(19) United States
(12) Patent Application Publication
(10) Pub. No.: US 2026/0247012 A1
(43) Pub. Date: Aug. 20, 2026

(54) VIDEO PROCESSING APPARATUS, VIDEO PROCESSING METHOD, AND PROGRAM

(71) Applicant: SONY GROUP CORPORATION, TOKYO (JP)

(72) Inventors: MINORI MANABE, TOKYO (JP); REIKO KIRIHARA, TOKYO (JP)

(21) Appl. No.: 18/839,808

(22) PCT Filed: Feb. 15, 2023
(86) PCT No.: PCT/JP2023/005104

§ 371 Date: Aug. 20, 2024

(30) Foreign Application Priority Data
Feb. 28, 2022 (JP) 2022-029969

(51) Int. Cl. H04N 21/81; G06V 40/16; H04N 21/44; H04N 21/845; H04N 21/854

(52) U.S. Cl. CPC H04N 21/816; G06V 40/174; H04N 21/44008; H04N 21/8456; H04N 21/854

(57) ABSTRACT

The present disclosure relates to a video processing apparatus, a video processing method, and a program that enable generation of a video image with a camerawork reflecting a user's preference to a greater extent. A preset processing unit generates, from a video image and the script of a past movie directed by a predetermined movie director, preset information in which various scores representing the features of the past camerawork used in the movies directed by the movie director are registered, and a camerawork generation processing unit refers to the preset information about the movie director desired by the user, and generates a new camerawork recreating the features of the past camerawork on the basis of a new script that is the script of an image work to be newly produced. The present technology can be applied to a video processing apparatus that generates a video image with a camerawork recreating the style of past movies, for example.

### TECHNICAL FIELD

The present disclosure relates to a video processing apparatus, a video processing method, and a program, and more particularly, to a video processing apparatus, a video processing method, and a program designed for generating a video image with a camerawork reflecting a user's preference to a greater extent.

### BACKGROUND ART

Conventionally, when a video image is generated, a camerawork is created by manually setting the position of the camera with respect to an object such as a character. Meanwhile, in a case where it is desired to examine a plurality of cameraworks in a form that can be visually checked, it takes a lot of manpower and time to arrange a plurality of cameras and examine the cameraworks.

Therefore, as disclosed in Patent Document 1, there is a proposed technique for determining a camerawork reflecting a user's intention (for example, a specific intention to image a certain character in a certain size) on the basis of the scenario elements constituting an animation scenario, such as facial expressions and actions, for example.

### CITATION LIST

### Patent Document

Patent Document 1: Japanese Patent Application Laid-Open No. 2008-97233

### SUMMARY OF THE INVENTION

### Problems to be Solved by the Invention

However, the technique disclosed in Patent Document 1 does not take into consideration generation of a camerawork to a user's preference (for example, an abstract intention such as wishing to perform imaging to recreate the style of a desired movie director) and optimization of the camerawork through correction made by the user. Therefore, there is a demand for generation of a camerawork reflecting a user's preference to a greater extent.

The present disclosure is made in view of such circumstances, and aims to enable generation of a video image with a camerawork reflecting a user's preference to a greater extent.

### Solutions to Problems

A video processing apparatus according to one aspect of the present disclosure includes: a preset processing unit that generates, from a video image and a script of a past image work belonging to a predetermined category, preset information in which various scores representing features of a past camerawork used in the image work under the category are registered; and a camerawork generation processing unit that refers to the preset information under the category desired by a user, and generates a new camerawork recreating the features of the past camerawork on the basis of a new script that is the script of an image work to be newly produced.

A video processing method or a program according to one aspect of the present disclosure includes: generating, from a video image and a script of a past image work belonging to a predetermined category, preset information in which various scores representing features of a past camerawork used in the image work under the category are registered; and generating a new camerawork recreating the features of the past camerawork by referring to the preset information under the category desired by a user, on the basis of a new script that is the script of an image work to be newly produced.

In one aspect of the present disclosure, preset information in which various scores representing features of a past camerawork used in an image work under a predetermined category are registered is generated from a video image and the script of the past image work belonging to the category, and a new camerawork recreating the features of the past camerawork is generated by referring to the preset information under the category desired by a user, on the basis of a new script that is the script of an image work to be newly produced.

### BRIEF DESCRIPTION OF DRAWINGS

FIG. 1 is a block diagram illustrating an example configuration of an embodiment of a video processing apparatus according to the present technology.

FIG. 2 is a block diagram illustrating an example configuration of a preset processing unit.

FIG. 3 is a table illustrating an example of a facial expression/action type correspondence table.

FIG. 4 is a table illustrating an example of an emotion type correspondence table.

FIG. 5 is a table illustrating an example of a shot correspondence table.

FIG. 6 is a diagram for explaining an example of shot sizes, shot directions, and shot angles.

FIG. 7 is tables showing an example of a facial expression/action score table, an emotion score table, and a shot switching score table.

FIG. 8 is a flowchart for explaining a process of creating a facial expression/action score table.

FIG. 9 is a flowchart for explaining a process of creating an emotion score table.

FIG. 10 is a flowchart for explaining a process of creating a shot switching score table.

FIG. 11 is a block diagram illustrating an example configuration of a camerawork generation processing unit.

FIG. 12 is a diagram illustrating an example of a timeline.

FIG. 13 is a table illustrating an example of timeline data.

FIG. 14 is a table for explaining a process of obtaining a sum of a facial expression/action score and an emotion score.

FIG. 15 is a table for explaining a process of obtaining a total score.

FIG. 16 is a flowchart for explaining a process of creating and correcting a camerawork.

FIG. 17 is a flowchart for explaining a total score calculation process.

FIG. 18 is a flowchart for explaining a score table update process.

FIG. 19 is a block diagram illustrating an example configuration of a computer according to an embodiment of the present technology.

### MODE FOR CARRYING OUT THE INVENTION

In the description below, specific embodiments according to the present technology will be described in detail, with reference to the drawings.

### Example Configuration of a Video Processing Apparatus

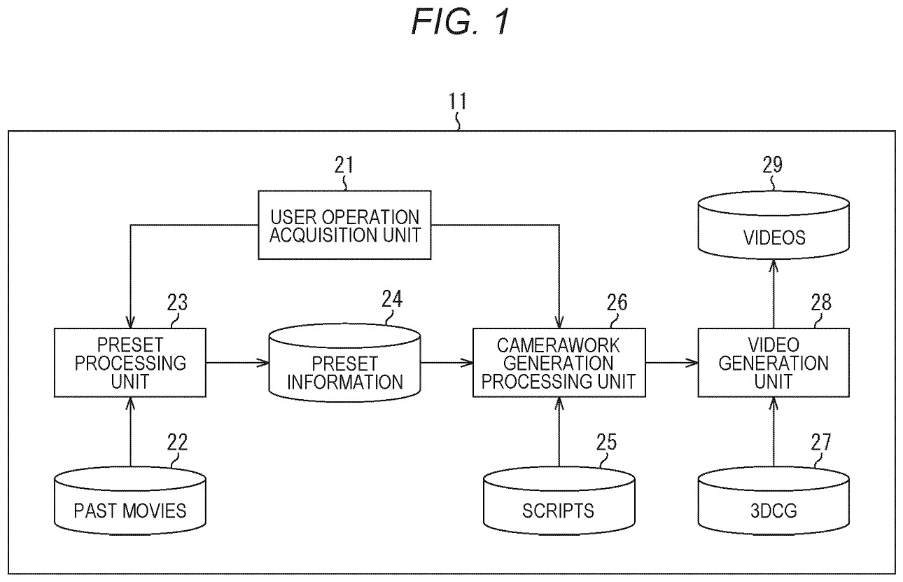

FIG. 1 is a block diagram illustrating an example configuration of an embodiment of a video processing apparatus according to the present technology.

As illustrated in FIG. 1, a video processing apparatus 11 includes a user operation acquisition unit 21, a past movie database 22, a preset processing unit 23, a preset information holding unit 24, a script storage unit 25, a camerawork generation processing unit 26, a 3DCG storage unit 27, a video generation unit 28, and a video storage unit 29. The video processing apparatus 11 generates a camerawork (for example, chronological changes in various settings related to the camera such as the position and direction of the camera, and the magnification and type of the lens) when generating a video image on the basis of a script and 3DCG, and performs video processing to generate a video image in accordance with the camerawork.

The user operation acquisition unit 21 acquires operating information corresponding to a user's operation on a user interface (not illustrated) such as a keyboard, a mouse, or a touch panel, for example. The user operation acquisition unit 21 then supplies the operating information to the preset processing unit 23 or the camerawork generation processing unit 26, in accordance with the contents of the operating information.

In the past movie database 22, videos and scripts of movies in the past are registered together with metadata (such as the name of the director and cast information, for example) of each movie. For example, the metadata is to be used for classifying the categories to which the movies belong.

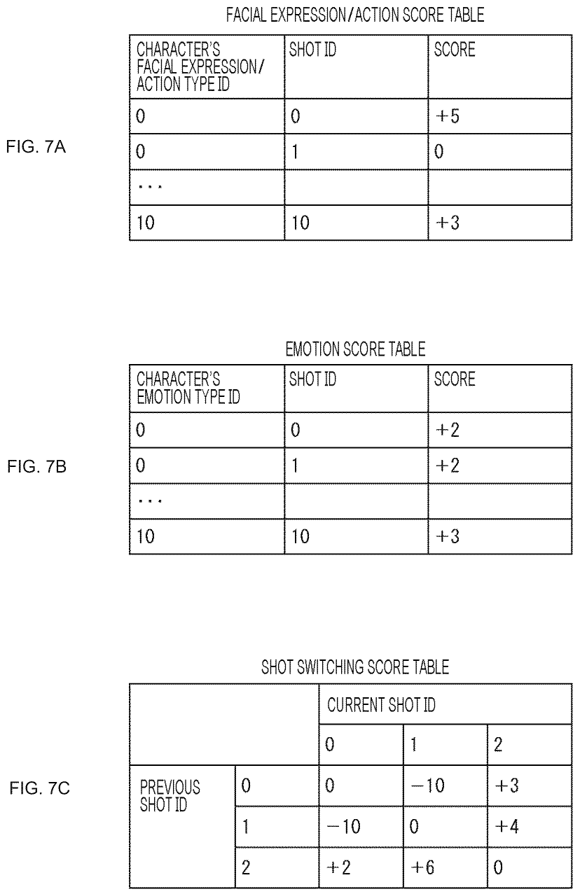

The preset processing unit 23 generates, for each movie director (category) of the movies registered in the past movie database 22, preset information necessary for generating a camerawork recreated to be the style of each movie director, and supplies the preset information to the preset information holding unit 24. Further, when operating information corresponding to an operation of the user instructing to correct the camerawork is supplied from the user operation acquisition unit 21, the preset processing unit 23 updates the preset information in response to the correction of the camerawork by the user. For example, the preset processing unit 23 generates a facial expression/action score table, an emotion score table, and a shot switching score table as illustrated in FIG. 7 to be described later, as the preset information.

The preset information holding unit 24 holds the preset information generated by the preset processing unit 23. Further, when the preset information is updated by the preset processing unit 23 in response to the correction of the camerawork by the user, the preset information holding unit 24 can hold the updated preset information separately from the preset information prior to the update.

The script storage unit 25 stores the script to be used when the user generates a video image using the video processing apparatus 11.

When the operating information corresponding to the operation of the user instructing to generate a video image with the camerawork by a desired movie director is supplied from the user operation acquisition unit 21, for example, the camerawork generation processing unit 26 acquires, from the preset information holding unit 24, the preset information generated from the past movies directed by the movie director. The camerawork generation processing unit 26 then reads the script stored in the script storage unit 25, generates the camerawork on the basis of the preset information, and supplies the camerawork to the video generation unit 28.

The 3DCG storage unit 27 stores the three-dimensional computer graphics (3DCG) to be used when the user generates a video image using the video processing apparatus 11. For example, the 3DCG stored in the 3DCG storage unit 27 is data indicating the three-dimensional operation of the CG model according to the time series and created on the basis of the script stored in the script storage unit 25, and is data including no cameraworks.

In accordance with the camerawork supplied from the camerawork generation processing unit 26, the video generation unit 28 generates a video image using the 3DCG read from the 3DCG storage unit 27, and supplies the video image to the video storage unit 29.

The video storage unit 29 stores the video image generated by the video generation unit 28. For example, the user can read the video image stored in the video storage unit 29, cause a display device (not illustrated) to display the video image, and perform an operation for correcting the camerawork while viewing the video image.

The video processing apparatus 11 designed as described above can automatically generate a camerawork recreated to be the style of a movie director desired by the user, and generate a video image with the camerawork. Moreover, the video processing apparatus 11 can generate a video image with the camerawork corresponding to the user's correction. Thus, the video processing apparatus 11 can generate a video image with the camerawork reflecting the user's preference to a greater extent.

For example, the user can select the preset information, on the basis of the genre or the like of the script to be used to generate a video image.

### Example Configuration and the Preset Processing Unit and Example Processing to Be Performed by the Preset Processing Unit

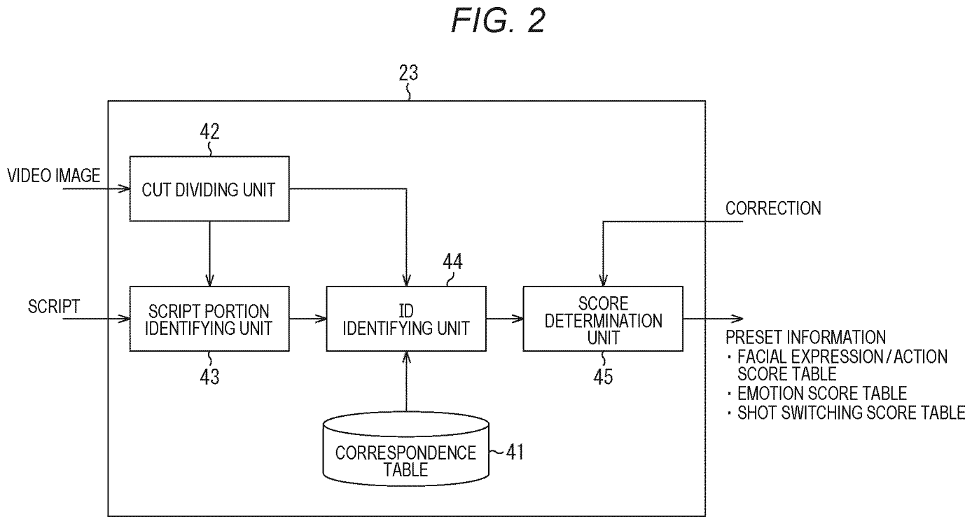

Referring now to FIGS. 2 to 10, an example configuration of the preset processing unit 23 and the processing to be performed in the preset processing unit 23 are described.

As illustrated in FIG. 2, the preset processing unit 23 includes a correspondence table storage unit 41, a cut dividing unit 42, a script portion identifying unit 43, an ID identifying unit 44, and a score determination unit 45.

The correspondence table storage unit 41 stores a facial expression/action type correspondence table, an emotion type correspondence table, and a shot correspondence table to be referred to by the ID identifying unit 44.

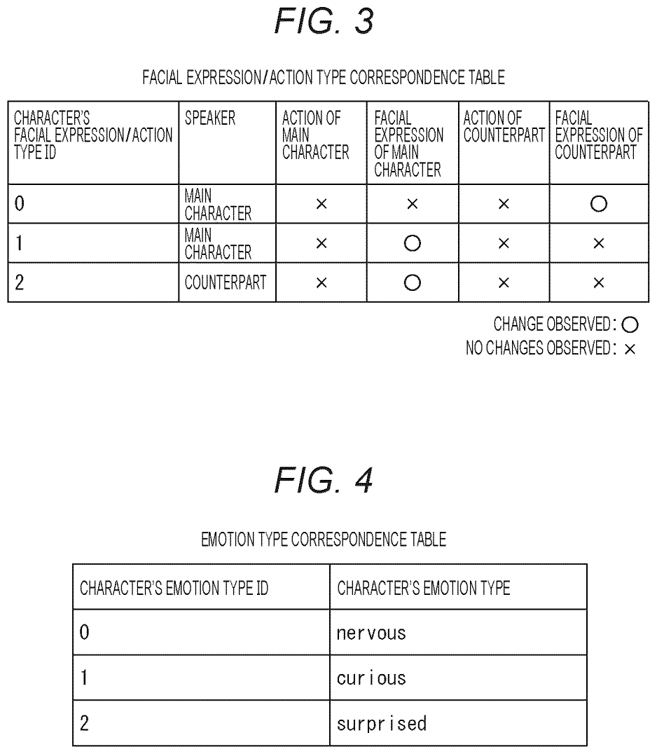

As illustrated in FIG. 3, in the facial expression/action type correspondence table, information indicating the speaker and information indicating the presence or absence of a change in the facial expression and action of the characters (the main character and the counterpart) are associated with character's facial expression/action type IDs. In the example illustrated in FIG. 3, information indicating that the speaker is the main character, there is no change in the action of the main character, there is no change in the facial expression of the main character, there is no change in the action of the counterpart, and there is a change in the facial expression of the counterpart is associated with a character's facial expression/action type ID: 0.

As illustrated in FIG. 4, in the emotion type correspondence table, information indicating emotion types of the characters is associated with character's emotion type IDs. For example, the emotion types of the characters include nervous, curious, surprised, and the like. In the example illustrated in FIG. 4, information indicating that the emotion type of the characters is nervous is associated with a character's emotion type ID: 0.

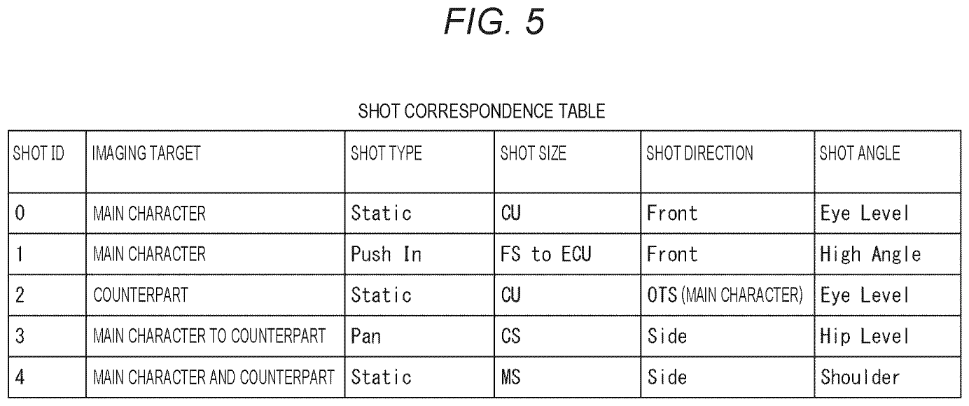

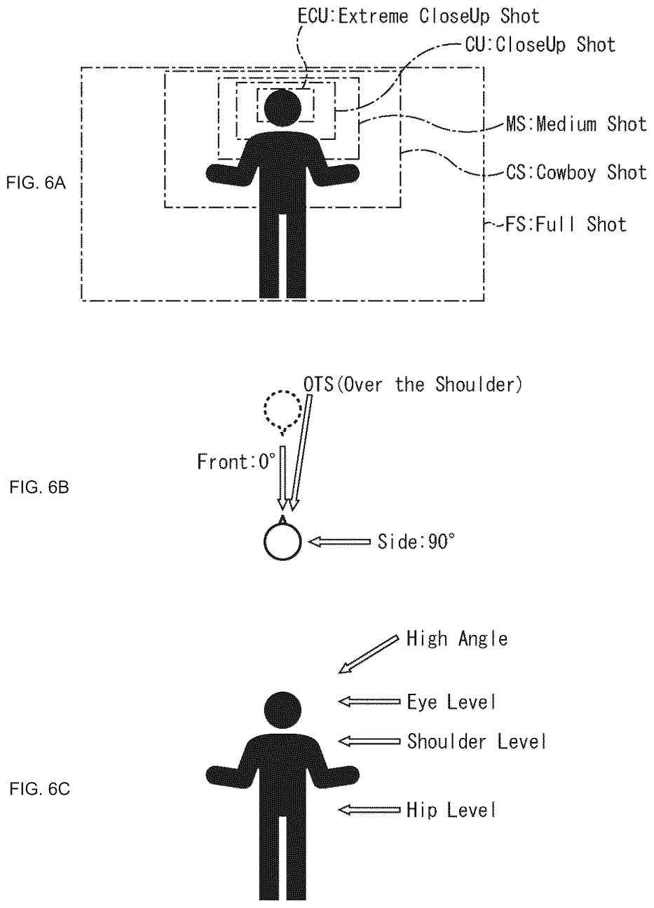

In the shot correspondence table, as illustrated in FIG. 5, information indicating an imaging target, a shot type, a shot size, a shot direction, and a shot angle is associated with shot IDs. For example, shot types include “static”, “push-in”, “pan”, and the like. As illustrated in A of FIG. 6, shot sizes include an extreme close-up shot, a close-up shot, a medium shot, a cowboy shot, a full shot, and the like. As illustrated in B of FIG. 6, shot directions include “front”, “over the shoulder”, “side”, and the like. As illustrated in C of FIG. 6, shot angles include high angle, eye level, shoulder level, hip level, and the like. In the example illustrated in FIG. 5, information indicating that the imaging target is the main character, the shot type is “static”, the shot size is a close-up shot, the direction of the shot is “front”, and the shot angle is at the eye level is associated with a shot ID: 0.

The cut dividing unit 42 acquires, from the past movie database 22 illustrated in FIG. 1, the video image of a movie directed by the movie director as the processing target in generating preset information. The cut dividing unit 42 then divides the video image into the respective cuts, which are the sections between which the camera capturing the video image is switched, and supplies the video image divided into the respective cuts to the script portion identifying unit 43 and the ID identifying unit 44. For example, a cut is a video section that lasts until imaging targets, shot types, shot sizes, shot directions, or shot angles are switched. The script portion identifying unit 43 acquires the script of the video image acquired by the cut dividing unit 42, from the past movie database 22 in FIG. 1. The script portion identifying unit 43 then collates the video image of each cut supplied from the cut dividing unit 42 with the script, identifies to which portion of the script (hereinafter referred to as a script portion) each cut corresponds, and supplies the script identifying the script portion of each cut to the ID identifying unit 44.

The ID identifying unit 44 identifies the facial expression/action type ID, the emotion type ID, and the shot ID in each cut, using the video images divided into the respective cuts by the cut dividing unit 42 and the script in which the script portions have been identified for the respective cuts by the script portion identifying unit 43, and supplies the identified facial expression/action type IDs, emotion type IDs, and shot IDs to the score determination unit 45. For example, the ID identifying unit 44 can perform a process of identifying a facial expression/action type ID, an emotion type ID, and a shot ID for each of the processing target cuts starting from the first cut in the video image of the movie.

For example, the ID identifying unit 44 performs natural language processing on the script portion corresponding to a processing target cut, to recognize actions, facial expressions, and the like of the characters. The ID identifying unit 44 then refers to the facial expression/action type correspondence table (FIG. 3) stored in the correspondence table storage unit 41 on the basis of the recognition result, to identify the facial expression/action type IDs of the characters in the processing target cut.

The ID identifying unit 44 also performs natural language processing on the script portion corresponding to the processing target cut, to recognize emotions of the characters. The ID identifying unit 44 then refers to the emotion type correspondence table (FIG. 4) stored in the correspondence table storage unit 41 on the basis of the recognition result, to identify the emotion type IDs of the characters in the processing target cut.

The ID identifying unit 44 also performs an image recognition process on the video image corresponding to the processing target cut, to recognize the imaging target, the shot type, the shot size, the shot direction, and the shot angle. For example, the ID identifying unit 44 can estimate the imaging target using a facial recognition process on the subject shown in the video image and cast information obtained from the metadata of the movie, and estimate from which angle the imaging has been performed by recognizing the position and orientation of the imaging target. The ID identifying unit 44 then refers to the shot correspondence table (FIG. 5) stored in the correspondence table storage unit 41 on the basis of the recognition result, to identify the shot IDs of the characters in the processing target cut. For example, a shot ID is for identifying the type of a shot defined by a combination of an imaging target, a shot type, a shot size, a shot direction, and a shot angle, and shots having the same combination have the same shot ID.

Specifically, the ID identifying unit 44 can identify the character's facial expression/action type ID as 0, in a case where the speaker is the main character, there are no changes in the action or facial expression of the main character, there are no changes in the action of the counterpart but there is a change in the facial expression of the counterpart in the script portion corresponding to the processing target cut. Also, the ID identifying unit 44 can identify the emotion type ID of the main character as 0, in a case where the main character is nervous in the script portion corresponding to the processing target cut. Further, the ID identifying unit 44 can identify the shot ID as 0, in a case where the main character has been imaged in a static manner at the eye level from the front side of a close-up shot in the script portion corresponding to the processing target cut. Accordingly, the ID identifying unit 44 can identify the processing target cut as a video image that has been captured so that the shot ID is 0 in a script in which the facial expression/action type ID is 0 and the emotion type ID of the main character is 0.

The score determination unit 45 determines a facial expression/action score, an emotion score, and a shot switching score, on the basis of the facial expression/action type ID, the emotion type ID, and the shot ID supplied from the ID identifying unit 44. The facial expression/action score is the number of times the combination of the character's facial expression/action type ID of shot ID is used. The emotion score is the number of cuts in which the combination of the emotion type ID and the shot ID is used. The shot switching score is the number of times the combination of the shot ID of the current cut and the shot ID of the previous cut is used when the cuts are switched. The score determination unit 45 then calculates these numbers of times for all the cuts of all the movies directed by the movie director as the processing target in generating preset information, creates the facial expression/action score table in which the facial expression/action score is registered, the emotion score table in which the emotion score is registered, and the shot switching score table in which the shot switching score is registered, and outputs the created tables as the preset information.

For example, when the combination of the character's facial expression/action type ID and shot ID is identified for each processing target cut, the score determination unit 45 increments the facial expression/action score of the combination. As a result, a facial expression/action score table as illustrated in A of FIG. 7 is created. The example illustrated in A of FIG. 7 indicates that there are five cuts in which the combination of the character's facial expression/action type ID: 0 and shot ID: 0 is used.

Further, when the combination of the character's emotion type ID and shot ID is identified for each processing target cut, the score determination unit 45 increments the emotion score of the combination. As a result, an emotion score table as illustrated in B of FIG. 7 is created. The example illustrated in B of FIG. 7 indicates that there are two cuts in which the combination of the character's emotion type ID: 0 and shot ID: 0 is used.

Further, when the combination of the shot ID of the current cut and the shot ID of the previous cut is identified each time cuts are switched, the score determination unit 45 increments the shot switching score of the combination. As a result, a shot switching score table as illustrated in C of FIG. 7 is created. The example illustrated in C of FIG. 7 indicates that cuts in which the combination of the shot ID: 2 of the current cut and the shot ID: 0 of the previous cut is used have been switched three times.

For example, in a case where the main character has been imaged in a static manner at the eye level from the front side of a close-up shot in the video image of a certain processing target cut, the shot ID of the processing target cut is 0. Subsequently, in a case where the counterpart has been imaged in a static manner at the eye level over the shoulder in a close-up shot (over the shoulder of the main character) in the video image of the next processing target cut, the shot ID of the processing target cut is 2. Accordingly, the combination of the shot ID: 0 of the current cut and the shot ID: 2 of the previous cut is identified, and the shot switching score of the combination is incremented.

Further, after determining the shot switching scores for all the processing target cuts, the score determination unit 45 sets the shot switching score to a negative value having the same value as the maximum shot switching score or an absolute value equal to or greater than the maximum shot switching score for the cuts that are considered to be unpreferable for use in the shot switching as a theory in video representation such as jump cuts, for example. Thus, a shot switching score table that can avoid unfavorable shot switching such as a jump cut is completed. Note that it is possible to select whether or not to apply a theory in video representation that avoids unpreferable shot switching, depending on the user's settings.

Note that each value to be incremented when the facial expression/action score, the emotion score, and the shot switching score are determined can be changed to a value other than +1. Also, in the facial expression/action score table, the facial expression/action score is calculated in accordance with the facial expression in which the face of the speaker is mainly captured and the type of action in which the entire body is captured to match the portion to be imaged. However, the facial expression/action score may be calculated, with the person to which the speaker is talking being taken into consideration, in addition to the facial expression and the type of action.

Furthermore, in the emotion score table, the emotion score may be calculated, with the type of facial expression and the type of action being taken into consideration, in addition to the type of emotion. Further, the emotion score may be calculated with additional use of some other category, in accordance with the position (the first half, the middle portion, the second half, or the like) in the scene. Furthermore, the facial expression/action score and the emotion score may be calculated on the basis of three or more characters.

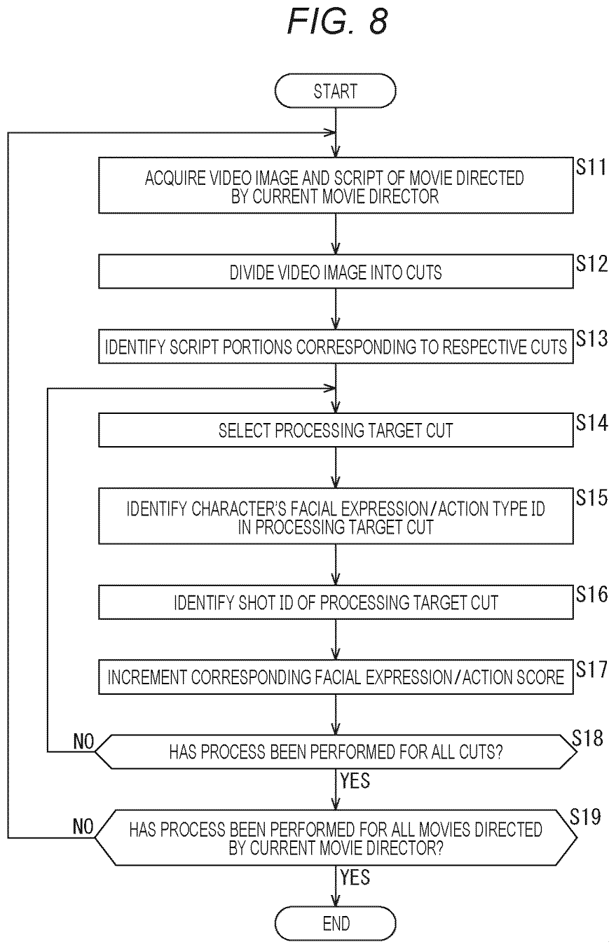

Referring now to a flowchart shown in FIG. 8, a process to be performed by the preset processing unit 23 to generate a facial expression/action score table in which facial expressions/actions are scored to recreate a camerawork that is the style of a certain movie director is described.

In step S11, the cut dividing unit 42 acquires the video image of a certain movie among the movies directed by the movie director as the processing target in generating preset information, and the script portion identifying unit 43 acquires the script of the movie.

For example, in a case where the process in step S11 is performed for the first time, the video and the script of a desired movie are acquired. In a case where the process in step S11 is performed for the second or later time, the video image and the script of a movie that has not been processed yet are acquired.

In step S12, the cut dividing unit 42 divides the video image into the respective cuts of the video image acquired in step S11, and supplies the divided video images of the respective cuts to the script portion identifying unit 43 and the ID identifying unit 44.

In step S13, the script portion identifying unit 43 collates the script acquired in step S11 with the divided video images of the respective cuts supplied from the cut dividing unit 42 in step S12, identifies the script portions corresponding to the respective cuts, and supplies the script portions to the ID identifying unit 44.

In step S14, the ID identifying unit 44 selects a processing target cut as the processing target, starting from the first cut, for example.

In step S15, the ID identifying unit 44 refers to the facial expression/action type correspondence table in FIG. 3, and identifies the facial expression/action type ID of the character in the processing target cut, in accordance with the action and the facial expression of the character recognized on the basis of the script portion corresponding to the processing target cut.

In step S16, the ID identifying unit 44 refers to the shot correspondence table in FIG. 5 and identifies the shot ID of the processing target cut, in accordance with the imaging target, the shot type, the shot size, the shot direction, and the shot angle recognized on the basis of the video image corresponding to the processing target cut.

In step S17, the score determination unit 45 increments the facial expression/action score corresponding to the combination of the character's facial expression/action type ID identified in step S15 and the shot ID identified in step S16.

In step S18, the score determination unit 45 determines whether or not the processes in steps S15 to S17 have been performed for all the cuts. In step S18, if the score determination unit 45 determines that the processes in steps S15 to S17 have not been performed for all the cuts, the process returns to step S14, and similar processes are repeated for the next cut. In step S18, if the score determination unit 45 determines that the processes in steps S15 to S17 have been performed for all the cuts, on the other hand, the process moves on to step S19.

In step S19, the preset processing unit 23 determines whether or not the process of generating a facial expression/action score table has been performed for all the movies directed by the movie director as the processing target in generating a facial expression/action score table.

In step S19, if the preset processing unit 23 determines that the process of generating a facial expression/action score table has not been performed for all the movies directed by the movie director as the processing target in generating a facial expression/action score table, the process returns to step S11. That is, in this case, the process of generating a facial expression/action score table is performed with the video image and the script of a movie that has not been subjected to the process of generating a facial expression/action score table among the movies directed by the movie director as the processing target in generating preset information.

In step S19, if the preset processing unit 23 determines that the process of generating a facial expression/action score table has been performed for all the movies directed by the movie director as the processing target in generating a facial expression/action score table, on the other hand, the process comes to an end. That is, in this case, a facial expression/action score table in which the facial expression/action scores obtained from all the cuts of all the movies directed by the movie director as the processing target in generating a facial expression/action score table are registered is completed, and the facial expression/action score table is supplied to the preset information holding unit 24.

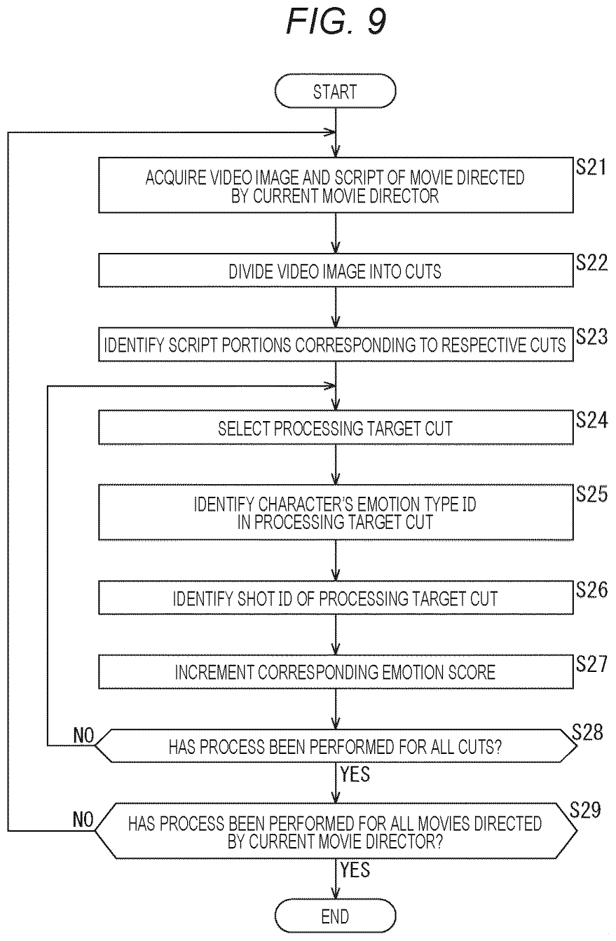

Referring now to a flowchart shown in FIG. 9, a process to be performed by the preset processing unit 23 to generate an emotion score table in which emotions are scored to recreate a camerawork that is the style of a certain movie director is described.

Processes in steps S21 to S24 are performed in a manner similar to the processes in the steps S11 to S14 in FIG. 8. After that, in step S25, the ID identifying unit 44 refers to the emotion type correspondence table in FIG. 4, and identifies the emotion type ID of the character in the processing target cut, in accordance with the emotion of the character recognized on the basis of the script portion corresponding to the processing target cut.

In step S26, the ID identifying unit 44 refers to the shot correspondence table in FIG. 5, and identifies the shot ID of the processing target cut, as in step S16 in FIG. 8.

In step S27, the score determination unit 45 increments the emotion score corresponding to the combination of the character's emotion type ID identified in step S25 and the shot ID identified in step S26.

In steps S28 and S29, processes similar to those in steps S18 and S19 in FIG. 8 are performed. After that, in step S29, if the preset processing unit 23 determines that the process of generating an emotion score table has been performed for all the movies directed by the movie director as the processing target in generating an emotion score table, the process comes to an end. That is, in this case, an emotion score table in which the emotion scores obtained from all the cuts of all the movies directed by the movie director as the processing target in generating an emotion score table are registered is completed, and the emotion score table is supplied to the preset information holding unit 24.

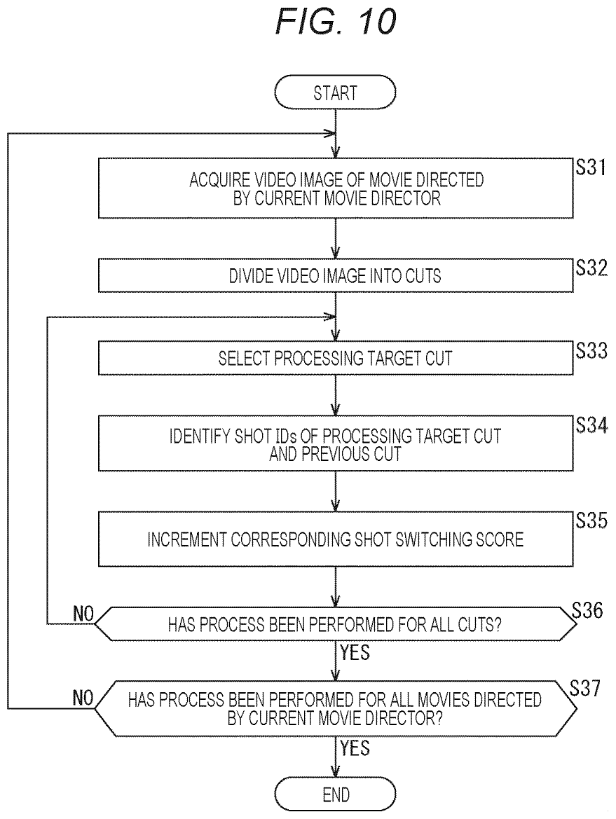

Referring now to a flowchart shown in FIG. 10, a process to be performed by the preset processing unit 23 to generate a shot switching score table in which shot switching is scored to recreate a camerawork that is the style of a certain movie director is described.

Processes in steps S31 and S32 are performed in a manner similar to the processes in the steps S11 and S12 in FIG. 8. After that, in step S33, the ID identifying unit 44 selects a processing target cut as the processing target, starting from the first cut, for example.

In step S34, the ID identifying unit 44 refers to the shot correspondence table in FIG. 5 and identifies the shot ID of the processing target cut, in accordance with the imaging target, the shot type, the shot size, the shot direction, and the shot angle recognized on the basis of the video image of the processing target cut.

Note that, in a case where the processing target cut is the first cut, the process returns to step S33 after the process in step S34. In a case where the processing target cut is the second or later cut, the process moves on to step S35 after the process in step S34.

In step S35, the score determination unit 45 increments the shot switching score corresponding to the combination of the shot ID identified in step S34 this time and the shot ID identified in step S34 the previous time.

In steps S36 and S37, processes similar to those in steps S18 and S19 in FIG. 8 are performed. After that, in step S37, if the preset processing unit 23 determines that the process of generating a shot switching score has been performed for all the movies directed by the movie director as the processing target in generating an emotion score table, the process comes to an end. That is, in this case, a shot switching score table in which the shot switching scores obtained from the switching of all the cuts of all the movies directed by the movie director who is the processing target in generating a shot switching score table are registered is completed, and the shot switching score table is supplied to the preset information holding unit 24.

### Example Configuration of the Camerawork Generation Processing Unit, and an Example Process

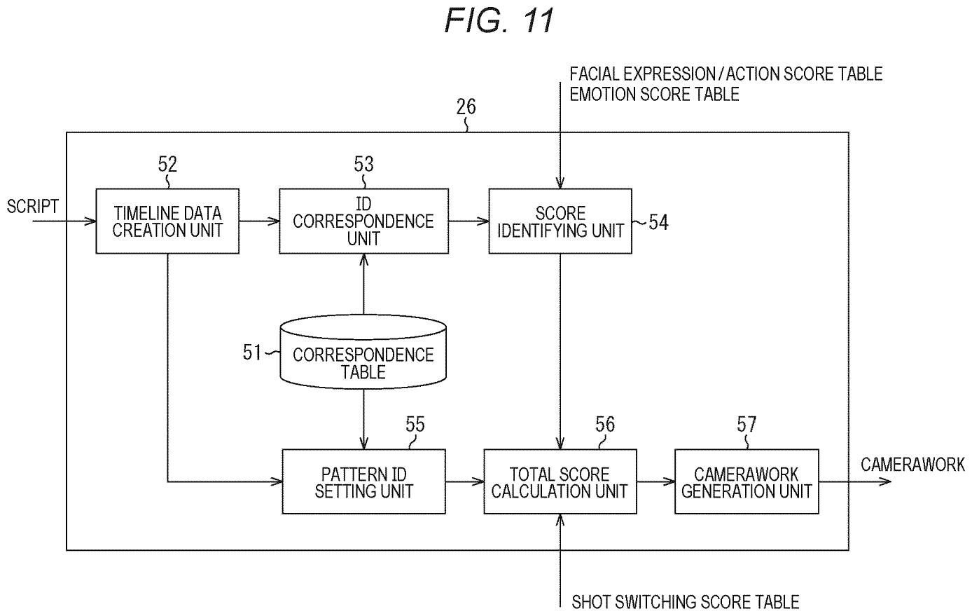

An example configuration of the camerawork generation processing unit 26 and a process to be performed in the camerawork generation processing unit 26 are now described with reference to FIGS. 11 to 18.

As illustrated in FIG. 11, the camerawork generation processing unit 26 includes a correspondence table storage unit 51, a timeline data creation unit 52, an ID association unit 53, a score identifying unit 54, a pattern ID setting unit 55, a total score calculation unit 56, and a camerawork generation unit 57.

The correspondence table storage unit 51 stores the facial expression/action type correspondence table (FIG. 3), the emotion type correspondence table (FIG. 4), and the shot correspondence table (FIG. 5), which are referred to by the ID association unit 53 and the pattern ID setting unit 55.

The timeline data creation unit 52 reads the script stored in the script storage unit 25, creates timeline data obtained by converting a timeline representing the contents of the script along the passage of time into data, and supplies the timeline data to the ID association unit 53 and the pattern ID setting unit 55.

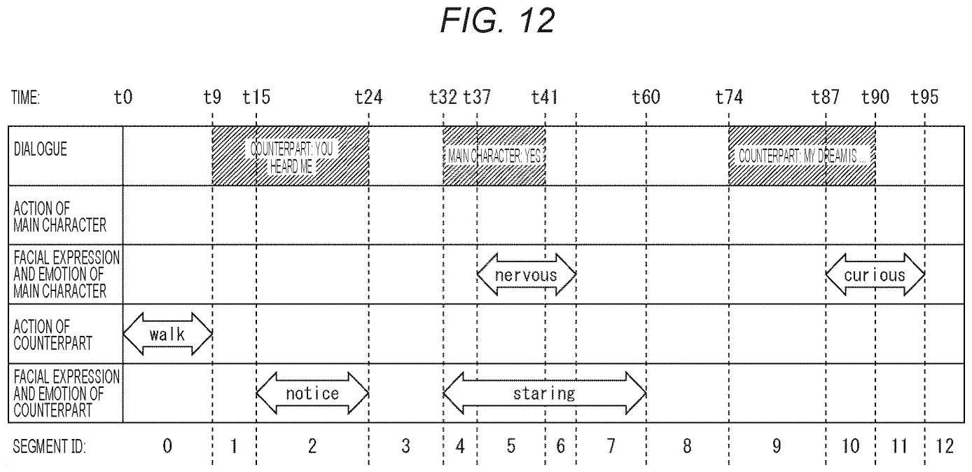

FIG. 12 illustrates an example of a timeline of one scene that is a unit in a script that is continuous in time series. Scenes are written in general movie scripts.

For example, a timeline includes dialogues, and actions, facial expressions, and emotions of each character in chronological order. Furthermore, in the timeline, all the dialogues, and the start and end points of the actions and facial expressions/emotions of the respective characters are set as cut point candidates (times indicated by dashed lines in FIG. 12) for switching the camera. Further, the sections separated by the respective cut point candidates are set as segments. That is, the segments are the minimum units having the same information for score calculation, and segment IDs are sequentially set to the respective segments, starting from the top.

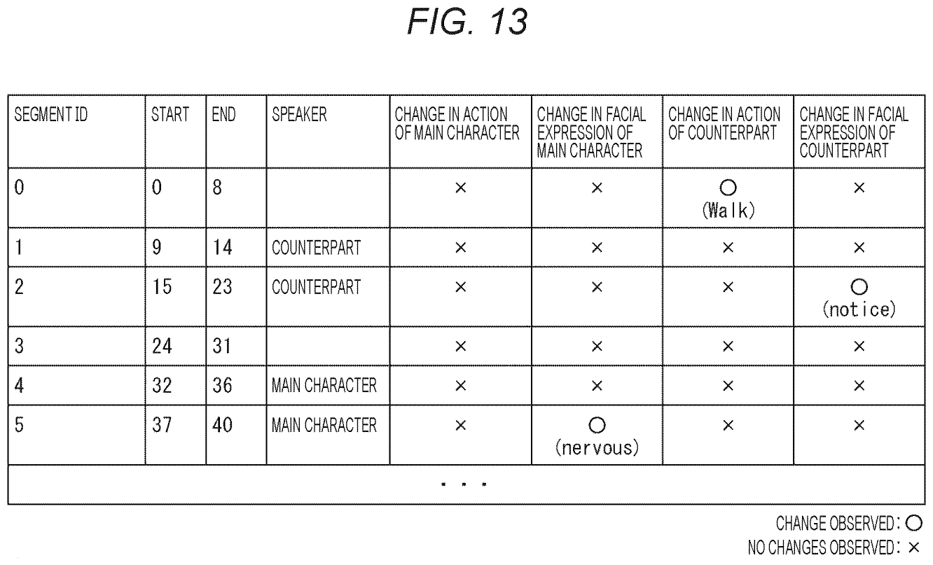

Such a timeline is then turned into data, so that timeline data as illustrated in FIG. 13 is created. In the example illustrated in FIG. 13, each segment ID is associated with a start time, an end time, a speaker, a change in the action of the main character, a change in the facial expression of the main character, a change in the action of the counterpart, and a change in the facial expression of the counterpart. For example, in the period from a start time t37 to an end time t40, the segment ID: 5 is associated with that a situation where the speaker is the main character, there are no changes in the action of the main character but there is a change in the emotion to be nervous, and there are no changes in the action and facial expression of the counterpart. Note that the timeline data creation unit 52 can edit the timeline data in accordance with the user's operation. For example, the dialogues, and the start and end points of the action and facial expression/emotion of each character can be edited.

The ID association unit 53 refers to the facial expression/action type correspondence table and the emotion type correspondence table stored in the correspondence table storage unit 51, and associates the facial expression/action type IDs and the emotion type IDs of the characters in each segment, on the basis of the timeline data supplied from the timeline data creation unit 52.

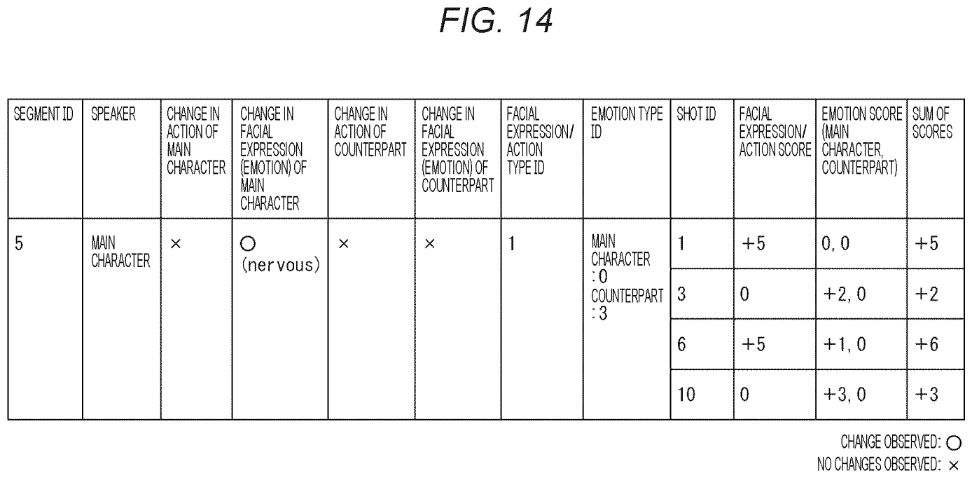

For example, in the example illustrated in FIG. 14, for the segment ID: 5 of the timeline data of FIG. 13, the facial expression/action type correspondence table is referred to on the basis of the situation where the speaker is the main character, there are no changes in the action of the main character but there is a change in the emotion, and there are no changes in the action and facial expression of the counterpart. Thus, the facial expression/action type ID of the character is associated with “1”. Furthermore, with respect to the segment ID: 5 of the timeline data in FIG. 13, the emotion type correspondence table is referred to on the basis of the situation where the emotion of the main character has changed to “nervous” while the emotion of the counterpart has not changed. Thus, the emotion type ID of the main character is associated with “0”, and the emotion type ID of the counterpart is associated with “3”.

The score identifying unit 54 acquires the facial expression/action score table and the emotion score table from the preset information holding unit 24 as the preset information generated from the past movies directed by the movie director, in accordance with the operating information corresponding to the user's operation instructing to generate a video image with the camerawork of the desired movie director. The score identifying unit 54 then refers to the facial expression/action score table and the emotion score table, and identifies the facial expression/action scores and the emotion scores for all the types of shot IDs in the respective segments, in accordance with the facial expression/action type IDs and the emotion type IDs of the characters associated with the respective segment IDs by the ID association unit 53.

For example, in the example illustrated in FIG. 14, in the segment ID: 5, the facial expression/action type ID of the character is associated with “1”, the emotion type ID of the main character is associated with “0”, and the emotion type ID of the counterpart is associated with “3”. As the facial expression/action score table and the emotion score table are referred to in accordance with this, the facial expression/action score: +5, the emotion score of the main character: 0, and the emotion score of the counterpart: 0 are identified with respect to the shot ID: 1, and the sum of these scores: +5 is obtained. Likewise, with respect to the shot ID: 3, the facial expression/action score: 0, the emotion score of the main character: +2, and the emotion score of the counterpart: 0 are identified, and the sum of these scores: +2 is obtained. Also, with respect to the shot ID: 6, the facial expression/action score: +5, the emotion score of the main character: +1, and the emotion score of the counterpart: 0 are identified, and the sum of these scores: +6 is obtained. Further, with respect to the shot ID: 10, the facial expression/action score: 0, the emotion score of the main character: +3, and the emotion score of the counterpart: 0 are identified, and the sum of these scores: +3 is obtained. Note that a sum of scores may be obtained for each character.

The pattern ID setting unit 55 sets a pattern ID for each segment ID of the timeline data in one scene supplied from the timeline data creation unit 52, with respect to a shot ID list in which all the patterns of sequences of shot IDs are listed. For example, a sequence of shot IDs is called a pattern, and the number of all patterns of sequences of shot IDs is a power of the total number of segments with respect to the shot IDs.

The total score calculation unit 56 acquires the shot switching score table from the preset information holding unit 24 as the preset information generated from the past movies directed by the movie director, in accordance with the operating information corresponding to the user's operation instructing to generate a video image with the camerawork of the desired movie director. The total score calculation unit 56 then refers to the shot switching score table, and calculates the total value of the shot switching scores for all the shot IDs, in accordance with the shot ID list for each pattern ID listed by the pattern ID setting unit 55.

Further, the total score calculation unit 56 calculates the total value of the facial expression/action scores and the emotion scores identified by the score identifying unit 54 for each shot ID list of each pattern ID set by the pattern ID setting unit 55. The total score calculation unit 56 then calculates a sum of the total value of the shot switching scores and the total value of the facial expression/action scores and the emotion scores, as the total score for each pattern ID.

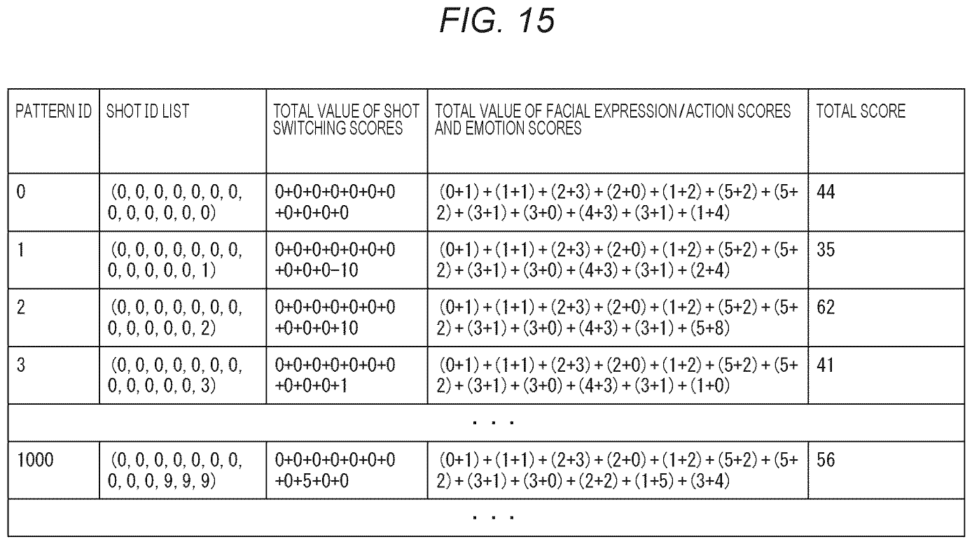

For example, in an example illustrated in FIG. 15, for the pattern ID: 1 that has been set for a shot ID list (0,0, 0, 0, 0, 0, 0, 0, 0, 0, 0, 0, 1), the total value of the shot switching scores (0+0+0+0+0+0+0+0+0+0−10) is calculated. That is, since the shot IDs of the segment ID: 1 to the segment ID: 10 remain 0 and do not change, the shot switching scores thereof are 0.

Further, in the switching of the shot from the segment ID: 11 to the segment ID: 12, the shot ID changes from 0 to 1, and therefore, the shot switching score is −10 according to the shot switching score table.

Furthermore, in the example illustrated in FIG. 15, for the pattern ID: 1 that has been set for a shot ID list (0, 0, 0, 0, 0, 0, 0, 0, 0, 0, 0, 0, 1), the total value ((0+1)+(1+1)+(2+3)+(2+0)+(1+2)+(5+2)+(5+2)+(3+1)+(3+0)+(4+3)+(3+1)+(2+4)) of the facial expression/action scores and the emotion scores in the respective shots from the segment ID: 1 to the segment ID: 12 is calculated. Further, from a sum of the total value of the shot switching scores and the total value of the facial expression/action scores and the emotion scores, the total score of the pattern ID: 0 is calculated to be 35.

The camerawork generation unit 57 selects the total score of the greatest value among the total scores of all the pattern IDs calculated by the total score calculation unit 56, and acquires the shot ID list from which the total score has been obtained. Note that, in a case where a plurality of cameraworks is presented, the camerawork generation unit 57 acquires shot ID lists from which the respective total scores have been obtained in descending order of the total scores. The camerawork generation unit 57 then generates a camerawork that is chronological changes in the imaging target, the shot type, the shot size, the shot direction, and the shot angle, in accordance with the acquired shot ID lists.

Here, on the basis of the shot ID list, the camerawork generation unit 57 creates a camerawork in a CG space so as not to go beyond an imaginary line (a virtual line connecting two characters) from the positional data of 3DCG characters or the like. Note that, in a case where a shot ID list created in the real space is adopted, it is possible to manually reflect the settings and the installation position of the camera, or to apply a path in the 3DCG to an imaging robot, a drone, or the like. Further, in a case where an object in the CG space or the real space collides with the camera, options such as adopting only a camera path designed to avoid the object or suggesting a change in the position of the object may be presented. Note that, in the CG space, it is also possible to use a camera path that does not take into consideration a collision between the camera and the object.

The camerawork generated by the camerawork generation unit 57 is then supplied to the video generation unit 28 in FIG. 1, and the video generation unit 28 generates a video image by rendering 3DCG in accordance with the camerawork.

Further, the user who has viewed the video image is able to correct the video image. For example, as a first correction method for reflecting the correction made by the user in the video image, there is a method of changing the type of shot (changing the subject, the shot size, or the shot angle to any option).

By the first correction method, in a case where the type of shot of one generated cut has been changed, the facial expression/action score table and the emotion score table are corrected so that the shot before the change has a lower score while the shot after the change has a higher score. In a case where the user chooses to apply this correction to all the other shots, a process of generating a camerawork is performed in a manner similar to the above, on the basis of the facial expression/action score table and the emotion score table that have been newly corrected.

For example, when the user changes to the shot ID: 3 in a situation where the shot ID: 1 has been selected while the segment ID: 5 indicates “there is a change in the facial expression of the main character but there are no changes in the facial expression and action of the counterpart”, there is a high possibility that the shot ID: 1 selected in a segment in which “there is a change in the facial expression of the main character but there are no changes in the facial expression and action of the counterpart” will be the shot ID: 3. Note that, in practice, a change is made, with the shot switching score table being taken into consideration.

Further, as a second correction method for reflecting the correction made by the user in the video image, there is a method of manually and finely adjusting the position of the camera (changing parameters such as the position and the angle of the camera).

By the second correction method, specific camera parameters for the type of shot (such as the distance and angle to the subject) are changed, which also allows the user to select whether to apply the correction to all the cuts having the same shot ID for which correction has not been made. For example, in a case where the shot ID: 1 is selected in the segment ID: 5, and the camera is moved to a position slightly closer to the subject than in the generated video image though a close-up shot is used, the change can be performed on all the other segments corresponding to the shot ID: 1.

By such a correction method, preset information can be optimized for each user.

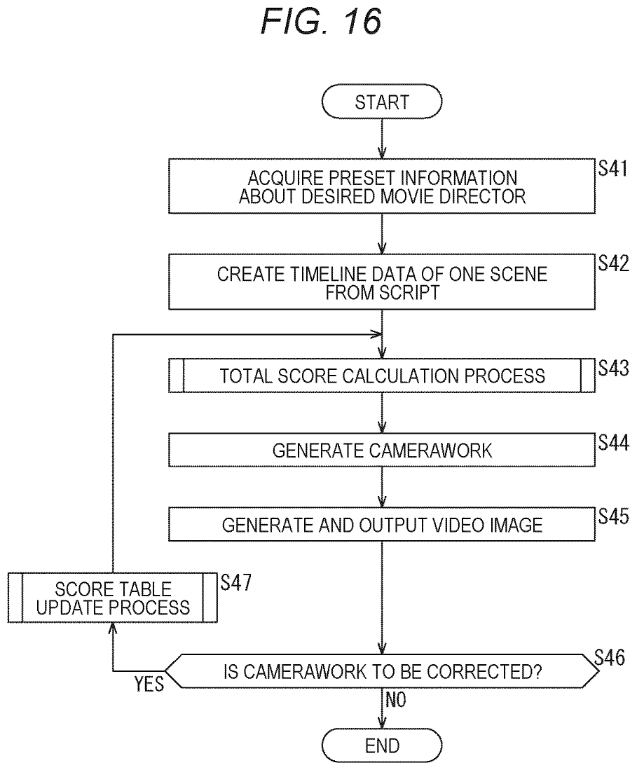

Referring now to a flowchart shown in FIG. 16, a process to be performed by the camerawork generation processing unit 26 to generate and correct a camerawork is described.

In step S41, the score identifying unit 54 acquires the facial expression/action score table and the emotion score table, and the total score calculation unit 56 acquires the shot switching score table, as the preset information generated from the past movies directed by the movie director, in accordance with the operating information according to the user's operation to instruct to generate a video image with the camerawork by the desired movie director.

In step S42, the timeline data creation unit 52 reads the script from the script storage unit 25 to create timeline data, and supplies the timeline data to the ID association unit 53 and the pattern ID setting unit 55.

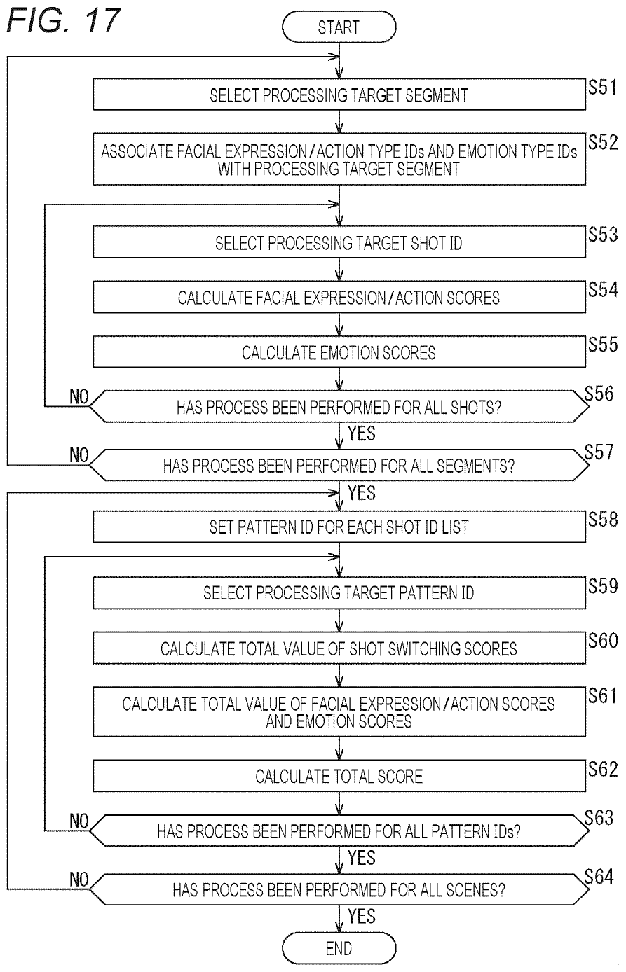

In step S43, as described above with reference to FIG. 15, a total score calculation processing (ass FIG. 17 to be described later) of calculating a total score obtained by adding the total value of the shot switching scores and the total value of the facial expression/action scores and the emotion scores is performed for each pattern ID.

In step S44, the camerawork generation unit 57 selects the total score having the greatest value among the total scores calculated for all the pattern IDs in step S43. The camerawork generation unit 57 then generates the camerawork according to the shot ID list from which the total score having the greatest value has been obtained, and supplies the camerawork to the video generation unit 28.

In step S45, the video generation unit 28 generates a video image by rendering 3DCG in accordance with the camerawork supplied from the camerawork generation unit 57 in step S44. The video image is then output to and displayed on a display device (not shown in the drawings).

In step S46, the video processing apparatus 11 determines whether or not to correct the camerawork generated in step S44, and, if the video processing apparatus 11 determines to correct the camerawork, the process moves on to step S47. For example, in a case where the user who has viewed the video image displayed on the display device in step S45 performs an operation of instructing to correct the camerawork, the operating information is acquired by the user operation acquisition unit 21, so that the video processing apparatus 11 can determine to correct the camerawork.

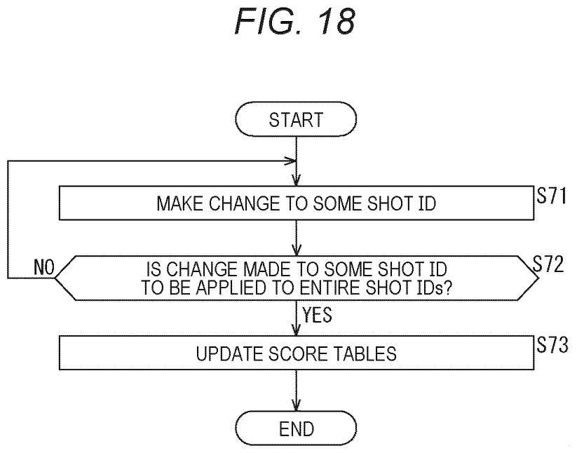

In step S47, a score table update process (see FIG. 18 to be described later) of updating the facial expression/action score table and the emotion score table in accordance with the correction made by the user is performed.

After the score table update process in step S47, the process returns to step S43, and processes similar to the above are performed with the facial expression/action score table and the emotion score table updated in the score table update process. A camerawork to which the correction is applied is then generated, and a video image generated according to the camerawork is output.

If the video processing apparatus 11 determines not to correct the camerawork in step S46, on the other hand, the process comes to an end. That is, in this case, as the user who has viewed the video image displayed on the display device in step S45 does not perform the operation of instructing to correct the camerawork, the video processing apparatus 11 can determine not to correct the camerawork.

FIG. 17 is a flowchart illustrating the total score calculation process to be performed in step S43 in FIG. 16.

In step S51, the ID association unit 53 selects a processing target segment as the processing target in a process of associating the facial expression/action type IDs and the emotion type IDs of the characters, starting from the first segment in the timeline supplied from the timeline data creation unit 52.

In step S52, the ID association unit 53 associates the facial expression/action type IDs and the emotion type IDs of the characters with the processing target segment selected in step S51, by referring to the facial expression/action type correspondence table and the emotion type correspondence table stored in the correspondence table storage unit 51.

In step S53, the score identifying unit 54 selects a processing target shot as the processing target in a process of identifying the facial expression/action scores and the emotion scores among all types of shots used for the processing target segment.

In step S54, the score identifying unit 54 refers to the facial expression/action score table in accordance with the facial expression/action type IDs of the characters associated in step S52, to calculate the facial expression/action scores for the processing target shot selected in step S53.

In step S55, the score identifying unit 54 refers to the emotion score table in accordance with the emotion type IDs of the characters associated in step S52, to calculate the emotion scores for the processing target shot selected in step S53.

In step S56, the score identifying unit 54 determines whether or not the process of identifying the facial expression/action scores and the emotion scores has been performed for all the shots.

In step S56, if the score identifying unit 54 determines that the process of identifying the facial expression/action scores and the emotion scores has not been performed for all the shots, the process returns to step S53, and processes similar to the above are repeated for a shot that has not been processed as a processing target.

In step S56, if the score identifying unit 54 determines that the process of identifying the facial expression/action scores and the emotion scores has been performed for all the shots, on the other hand, the process moves on to step S57.

In step S57, the ID association unit 53 determines whether or not the process of associating the facial expression/action type IDs and the emotion type IDs of the characters has been performed for all the segments.

In step S57, if the ID association unit 53 determines that the process of associating the facial expression/action type IDs and the emotion type IDs of the characters has not been performed for all the segments, the process returns to step S51, and processes similar to the above are repeated for the next segment as the processing target.

In step S57, if the ID association unit 53 determines that the process of associating the facial expression/action type IDs and the emotion type IDs of the characters has been performed for all the segments, on the other hand, the process moves on to step S58.

In step S58, the pattern ID setting unit 55 sets a pattern ID for each shot ID lest for all the segment IDs in the timeline data in one scene supplied from the timeline data creation unit 52.

In step S59, the total score calculation unit 56 selects a processing target pattern ID as the processing target in a process of calculating a total score, starting from the first pattern ID.

In step S60, the total score calculation unit 56 refers to the shot switching score table in accordance with the shot ID list for the processing target pattern ID, and calculates the total value of the shot switching scores for all the shot IDs having the processing target pattern ID.

In step S61, the total score calculation unit 56 calculates, for the processing target pattern ID, the total value of the facial expression/action scores identified by the score identifying unit 54 in step S54 and the emotion scores identified by the score identifying unit 54 in step S55.

In step S62, the total score calculation unit 56 calculates the sum of the total value of the shot switching scores calculated in step S60 and the total value of the facial expression/action scores and the emotion scores calculated in step S61, as the total score for the processing target pattern ID.

In step S63, the total score calculation unit 56 determines whether or not the process of calculating a total score has been performed for all the pattern IDs.

In step S63, if the total score calculation unit 56 determines that the process of calculating a total score has not been performed for all the pattern IDs, the process returns to step S59, and processes similar to the above are repeated for the next pattern ID as the processing target.

In step S63, if the total score calculation unit 56 determines that the process of calculating a total score has been performed for all the pattern IDs, on the other hand, the process moves on to step S64.

In step S64, the pattern ID setting unit 55 determines whether or not the process of calculating a total score for each pattern ID has been performed for all the scenes.

In step S64, if the pattern ID setting unit 55 determines that the process of calculating a total score for each pattern ID has not been performed for all the scenes, the process returns to step S58, and processes similar to the above are repeated for the next scene as the target.

In step S64, if the ID association unit 53 determines that the process of calculating a total score for each pattern ID has been performed for all the scenes, the process comes to an end.

FIG. 18 is a flowchart illustrating the score table update process to be performed in step S47 in FIG. 16.

In step S71, when the user performs an operation of correcting the type of some shot, the user operation acquisition unit 21 acquires the operating information, and supplies the operating information to the score determination unit 45. The score determination unit 45 then reads the facial expression/action score table and the emotion score table from the preset information holding unit 24, and changes the facial expression/action score table and the emotion score table so that the values of the facial expression/action score and the emotion score corresponding to the shot ID of the type of shot corrected by the user become higher.

In step S72, the score determination unit 45 presents a message indicating whether or not to apply the change made with respect to the shot ID to the entire shot IDs to the user, for example, and determines whether or not to apply the change made with respect to the shot ID to the entire shot IDs, depending on whether or not the user desires the change.

In step S72, if the score determination unit 45 determines not to apply the change made with respect to the shot ID to the entire shot IDs, the process returns to step S71, and the correction of the type of some shot by the user is continuously performed.

In step S72, if the score determination unit 45 determines to apply the change made with respect to the shot ID to the entire shot IDs, on the other hand, the process moves on to step S73.

In step S73, the score determination unit 45 applies a change that makes it easier to select the shot ID changed on the basis of the correction of the type of some shot by the user to the entire facial expression/action score table and the entire emotion score table. The score determination unit 45 then updates the facial expression/action score table and the emotion score table after the change, and causes the preset information holding unit 24 to hold the updated facial expression/action score table and emotion score table. The process then comes to an end.

After that, the process returns to step S43, in which processes similar to those described above are performed with reference to the updated facial expression/action score table and emotion score table, and a video image generated in accordance with the camerawork to which the correction made by the user is applied is output.

As described above, the video processing apparatus 11 can refer to scores obtained from the past movies, automatically generate a camerawork preferred by the user on the basis of the facial expressions, actions, emotions, and the like of the characters estimated from the script, and generate a video image in accordance with the camerawork using 3DCG applied to the script. For example, in addition to designating a movie director as a category, the video processing apparatus 11 may designate the titles of past movies, an age, a country name, or the like as a category, and may be able to select preset information, so that the video processing apparatus 11 can recreate a camerawork to present the style of those past movies. Further, the video processing apparatus 11 can allow the user to partially correct the camerawork generated on the basis of the preset information selected by the user, and causes the entire preset information to reflect the correction.

Note that, when the preset information is applied to the script, such as when the preset information is selected in accordance with an operation of the user instructing to generate a video image with the camerawork of a desired movie director, for example, various instructions may be issued in addition to the selection of the preset information.

For example, when an instruction is issued to emphasize facial expressions at this point of time, weighting can be performed so that the emotion score table becomes more important. Also, if an instruction is issued to use the same shot from the segment ID: 1 to the segment ID: 5 at this point of time, score calculation can be performed on the assumption that the same shot is used from the segment ID: 1 to the segment ID: 5.

Specifically, while it is normally necessary to calculate scores by applying all of (0, 1, 0, 3, 5, 1, 5, 0, 3, 0, 7, 0), (1, 0, 1, 5, 3, 5, 7, 8, 1, 9, 2, 4), . . . , and the like as patterns to the score table, score calculation is performed by narrowing down to (0, 0, 0, 0, 0, 1, 5, 0, 3, 0, 7, 0), (1, 1, 1, 1, 1, 5, 7, 8, 1, 9, 2, 4), . . . , and the like in response to such an instruction, and a frequently appearing one can be selected from among those scores.

Further, in this case, if an instruction is issued to use a high angle frequently for the main character, scores can be incremented for the shots using high angles. Also, in the segment ID: 6, if an instruction is issued to image the main character at a low angle from the front in a full shot, score calculation can be performed, with the shot of the segment ID: 6 being fixed. Alternatively, the upper limit of the number of shot types may be set to five, for example.

Further, such an instruction may be issued when the generation of a camerawork is started, or may be issued when the generated camerawork is corrected. Thus, reflection of correction of the camerawork can be optimized for each user.

Note that manual correction by the user may be performed with a virtual camera using AR, for example.

Further, in a case where video images generated in accordance with a plurality of cameraworks are to be presented to the user, a plurality of cameraworks is generated from those having high scores, and a plurality of video images generated in accordance with the cameraworks is displayed. The user is then enabled to determine the final camerawork by selecting the camerawork to be used from among the cameraworks of those video images, or by correcting some of the cameraworks.

Furthermore, the preset information updated on the basis of selection or correction by the user is held in the preset information holding unit 24 as information optimized for each user.

As the video processing apparatus 11 is used in previsualization at a production studio for movies or animations, for example, the costs for animation production by 3DCG can be lowered. Also, a user who does not have camerawork knowledge can produce a video image with an attractive camerawork in a short time, using the video processing apparatus 11. Further, with the video processing apparatus 11, it is possible to examine cameraworks, which has been difficult outside the imaging site, at low cost in advance. Also, it is possible to generate a plurality of optimal cameraworks at low cost on the basis of a script and 3DCG, and compare and examine the cameraworks.

Note that, although the present embodiment has been described with movies taken as an example, the present technology can be applied to moving images other than movies. For example, the present technology can be applied to moving images such as animations, music videos, cartoons, and commercial films in which scenarios or scripts are present, and there is 3DCG with an uncompleted camerawork. In addition to the above, the present technology can be applied to moving images with various reproduction times, such as variety shows, documentary shows, plays, speeches, music live shows, web moving images, and the like.

### Example Configuration of a Computer

Next, the series of processes (video processing method) described above can be performed by hardware or by software. In a case where the series of processes is performed by software, a program forming the software is installed into a general-purpose computer or the like.

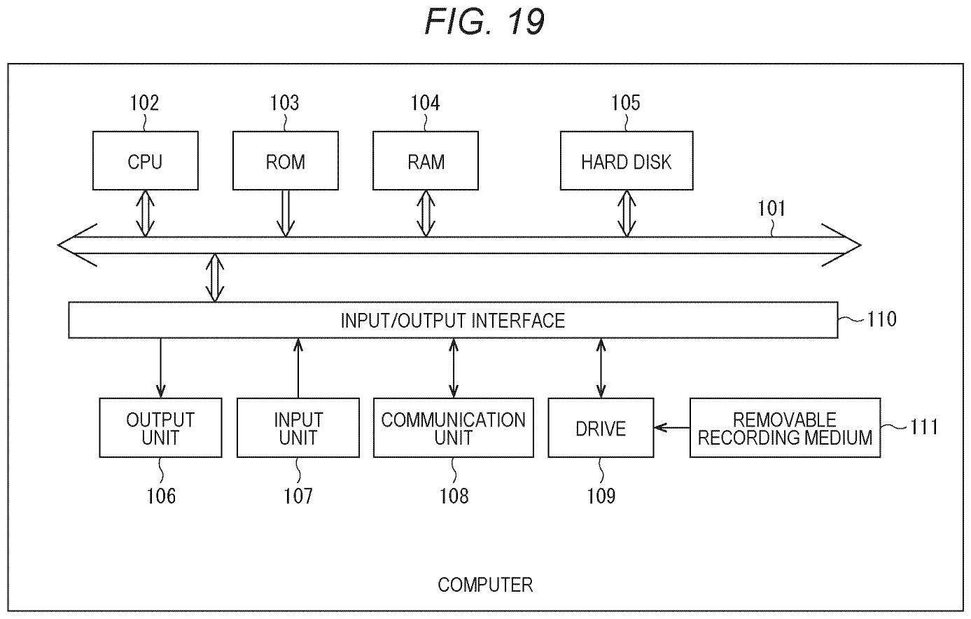

FIG. 19 is a block diagram illustrating an example configuration of an embodiment of a computer in which a program for performing the above-described series of processes is installed.

The program can be recorded beforehand on a hard disk 105 or a ROM 103 as a recording medium incorporated into the computer.

Alternatively, the program can be stored (recorded) in a removable recording medium 111 that is driven by a drive 109. Such a removable recording medium 111 can be provided as so-called packaged software. Here, the removable recording medium 111 may be a flexible disk, a compact disc read only memory (CD-ROM), a magneto optical (MO) disk, a digital versatile disc (DVD), a magnetic disk, a semiconductor memory, or the like, for example.

Note that, instead of being installed into the computer from the removable recording medium 111 as described above, the program can be downloaded into the computer via a communication network or a broadcasting network, and be installed into the hard disk 105 included therein. In other words, the program can be wirelessly transferred from a download site into the computer via an artificial satellite for digital satellite broadcasting, or can be transferred by a wire to the computer via a network such as a local area network (LAN) or the Internet, for example.

The computer includes a central processing unit (CPU) 102, and an input/output interface 110 is connected to the CPU 102 via a bus 101.

When a command is input by a user operating an input unit 107 via the input/output interface 110 or the like, the CPU 102 executes the program stored in the read only memory (ROM) 103 in accordance with the command.

Alternatively, the CPU 102 loads the program stored in the hard disk 105 into a random access memory (RAM) 104 to execute the program.

Accordingly, the CPU 102 performs processes according to the flowcharts described above, or the processes to be performed by components shown in the block diagrams described above. The CPU 102 then outputs a processing result from an output unit 106 or transmits the processing result from a communication unit 108 as necessary, for example, and further causes the hard disk 105 to record the processing result and the like, via the input/output interface 110, for example.

Note that the input unit 107 is formed with a keyboard, a mouse, a microphone, and the like.

Meanwhile, the output unit 106 is formed with a liquid crystal display (LCD), a speaker, and the like.

Here, in the present specification, the processes to be performed by the computer in accordance with the program are not necessarily performed in chronological order according to sequences described in the flowcharts. That is, the processes to be performed by the computer in accordance with the program include processes to be performed in parallel or independently of one another (parallel processing or object-based processing, for example).

Furthermore, the program may be executed by one computer (one processor) or be executed in a distributed manner by a plurality of computers. Moreover, the program may be transferred to a distant computer and be executed therein.

Further, in the present specification, a system means a set of a plurality of components (devices, modules (parts), and the like), and it does not matter whether or not all the components are in the same housing. Therefore, a plurality of devices that are included in different housings and are connected to each other via a network, and one device in which a plurality of modules is included in one housing are both systems.

Furthermore, a component described as one device (or one processing unit) may be divided and be designed as a plurality of devices (or processing units), for example. Conversely, components described above as a plurality of devices (or processing units) may be collectively designed as one device (or one processing unit). Furthermore, it goes without saying that a component other than the above-described components may be added to the components of each device (or each processing unit). Moreover, if the components and operations of the entire system are substantially the same, some of the components of a certain device (or processing unit) may be incorporated into the components of another device (or another processing unit).

Furthermore, the present technology can be configured as cloud computing in which one function is shared and jointly processed by a plurality of devices via a network, for example.

Further, the program described above can be executed by any device, for example. In that case, the device is only required to have necessary functions (functional blocks and the like) and obtain necessary information.

Furthermore, each of the steps described with reference to the flowcharts described above can be carried out by one device, or can be carried out in a shared manner by a plurality of devices, for example. Moreover, in a case where a plurality of processes is included in one step, the plurality of the processes included in the one step can be performed by one device or be shared and performed by a plurality of devices. In other words, a plurality of processes included in one step can also be performed as processes in a plurality of steps. Conversely, a process described as a plurality of steps can be collectively performed as one step.

Note that, in the program to be executed by the computer, the processes in steps describing the program may be performed in chronological order in the sequence described in the present specification, or may be executed in parallel, or independently at a necessary timing such as when a call is made. That is, unless there is a contradiction, the processes in the respective steps may be performed in an order different from the orders described above. Moreover, the processes in steps describing this program may be performed in parallel with processes according to another program, or may be performed in combination with processes according to another program.

Note that each of the aspects of the present technology that have been described in the present specification can be implemented independently as a single unit unless there is a contradiction. It is of course possible to implement a plurality of desired aspects of the present technology in combination. For example, part or all of the aspects of the present technology described in any of the embodiments can be implemented in combination with part or all of the aspects of the present technology described in other embodiments. Furthermore, part or all of any aspect of the present technology described above can be implemented together with another technology that is not described above.

### Example Combinations of Configurations

Note that the present technology can also have the configurations described below.

(1)

A video processing apparatus including:
a preset processing unit that generates, from a video image and a script of a past image work belonging to a predetermined category, preset information in which various scores representing features of a past camerawork used in the image work under the category are registered; and
a camerawork generation processing unit that refers to the preset information under the category desired by a user, and generates a new camerawork recreating the features of the past camerawork on the basis of a new script that is a script of an image work to be newly produced.
   (2)

The video processing apparatus according to (1), further including
a video generation unit that generates a video image of the image work to be newly produced, in accordance with the new camerawork, using 3DCG that is data indicating a three-dimensional operation of a time-series CG model created on the basis of the new script and is data without a camerawork.
   (3)

The video processing apparatus according to (2), in which
the preset processing unit includes: a cut dividing unit that acquires the video image of the past image work belonging to the category, and divides the video image into respective cuts that are sections between which a camera is switched in the video image; and
a script portion identifying unit that acquires the script of the past image work acquired by the cut dividing unit, and identifies script portions that are portions of the script corresponding to the respective cuts.
   (4)

The video processing apparatus according to (3), in which
the preset processing unit includes:
an ID identifying unit that identifies a facial expression/action type ID for identifying presence or absence of a change in a facial expression or an action of a character in the cut, an emotion type ID for identifying an emotion of the character in the cut, and a shot ID for identifying a type of shot in the cut, using the video image divided into the respective cuts and the script in which the script portions have been identified for the respective cuts; and
a score determination unit that determines, for processing targets that are all the cuts in all past image works belonging to the predetermined category, a facial expression/action score calculated in accordance with the number of cuts in which a combination of the facial expression/action type ID and the shot ID is used, an emotion score calculated in accordance with the number of cuts in which a combination of the emotion type ID and the shot ID is used, and a shot switching score calculated in accordance with the number of times the cuts using a combination of the shot IDs before and after switching of the cuts are switched, and
a facial expression/action score table in which the facial expression/action score is registered, an emotion score table in which the emotion score is registered, and a shot switching score table in which the shot switching score is registered are generated as the preset information.
   (5)

The video processing apparatus according to (4), in which
the ID identifying unit
identifies the facial expression/action type ID for each cut by referring to a facial expression/action type correspondence table in which the facial expression/action type ID of the character is associated with information indicating a speaker, and information indicating presence or absence of a change in the facial expression and action of the character,
identifies the emotion type ID for each cut by referring to an emotion type correspondence table in which the emotion type ID of the character is associated with information indicating an emotion type of the character, and
identifies the shot ID for each cut by referring to a shot correspondence table in which the shot ID is associated with information indicating an imaging target, a shot type, a shot size, a shot direction, and a shot angle.
   (6)

The video processing apparatus according to (5), in which
the score determination unit updates the entire facial expression/action score table and the entire emotion score table to change the facial expression/action score and the emotion score corresponding to the shot ID after correction to higher values in the facial expression/action score table and the emotion score table, in accordance with operating information about a user instructing to correct some of the shot IDs to correct the new camerawork, in response to display of the video image of the image work to be newly produced, the video image having been generated by the video generation unit in accordance with the new camerawork, and
the camerawork generation processing unit generates the new camerawork reflecting the correction, by referring to the updated facial expression/action score table and the updated emotion score table.
   (7)

The video processing apparatus according to (6), in which
the camerawork generation processing unit includes:
a timeline data creation unit that creates timeline data formed by turning a timeline into data for each segment that is a section defined by cut point candidates for switching the camera, the timeline representing contents of the new script with dialogues, and actions, facial expressions, and emotions of the respective characters over time;
an ID association unit that associates each segment with the facial expression/action type ID of each character in the segment by referring to the facial expression/action type correspondence table, and associates each segment with the emotion type ID of each character in the segment by referring to the emotion type correspondence table; and
a score identifying unit that refers to the facial expression/action score table and the emotion score table as the preset information about the desired category, and identifies the facial expression/action score and the emotion score for each shot ID assumed to be used in the segment.
   (8)

The video processing apparatus according to (7), in which
the camerawork generation processing unit further includes:
a pattern ID setting unit that sets a pattern ID for a shot ID list in which all patterns of sequences of the shot IDs are listed for each of the segments;
a total score calculation unit that refers to the shot switching scores as the preset information about the desired category, calculates a first total value by summing the shot switching scores for all the shot IDs in accordance with the shot ID list, calculates a second total value by summing the facial expression/action scores and the emotion scores, and calculates a sum of the first total value and the second total value as a total score for each of the pattern IDs; and
a camerawork generation unit that generates the new camerawork in accordance with the shot ID list from which a total score having the greatest value among the total scores for all the pattern IDs has been obtained.
   (9)

The video processing apparatus according to (8), in which,
when presenting a plurality of new cameraworks, the camerawork generation unit generates a plurality of the new cameraworks in accordance with the shot ID lists from which the respective total scores have been obtained, in descending order of the total scores.
   (10)

The video processing apparatus according to any one of (1) to (9), in which
the camerawork includes chronological changes in an imaging target, a shot type, a shot size, a shot direction, and a shot angle.
   (11)

A video processing method implemented by a video processing apparatus,
the video processing method including:
generating, from a video image and a script of a past image work belonging to a predetermined category, preset information in which various scores representing features of a past camerawork used in the image work under the category are registered; and
generating a new camerawork recreating the features of the past camerawork by referring to the preset information under the category desired by a user, on the basis of a new script that is a script of an image work to be newly produced.
   (12)

A program for causing a computer of a video processing apparatus to perform video processing that includes:
generating, from a video image and a script of a past image work belonging to a predetermined category, preset information in which various scores representing features of a past camerawork used in the image work under the category are registered; and
generating a new camerawork recreating the features of the past camerawork by referring to the preset information under the category desired by a user, on the basis of a new script that is a script of an image work to be newly produced.

Note that the present embodiment is not limited to the embodiment described above, and various modifications can be made to it without departing from the scope of the present disclosure. Furthermore, the effects described in the present specification are merely examples and are not restrictive, and some other effects may be achieved.

### REFERENCE SIGNS LIST

11 Video processing apparatus
21 User operation acquisition unit
22 Past movie database
23 Preset processing unit
24 Preset information holding unit
25 Script storage unit
26 Camerawork generation processing unit
27 3DCG storage unit
28 Video generation unit
29 Video storage unit
41 Correspondence table storage unit
42 Cut dividing unit
43 Script portion identifying unit
44 ID identifying unit
45 Score determination unit
51 Correspondence table storage unit
52 Timeline data creation unit
53 ID association unit
54 Score identifying unit
55 Pattern ID setting unit
56 Total score calculation unit
57 Camerawork generation unit

1. A video processing apparatus comprising:
a preset processing unit that generates, from a video image and a script of a past image work belonging to a predetermined category, preset information in which various scores representing features of a past camerawork used in the image work under the category are registered; and
a camerawork generation processing unit that refers to the preset information under the category desired by a user, and generates a new camerawork recreating the features of the past camerawork on a basis of a new script that is a script of an image work to be newly produced.

2. The video processing apparatus according to claim 1, further comprising
a video generation unit that generates a video image of the image work to be newly produced, in accordance with the new camerawork, using 3DCG that is data indicating a three-dimensional operation of a time-series CG model created on a basis of the new script and is data without a camerawork.

3. The video processing apparatus according to claim 2, wherein
the preset processing unit includes:
a cut dividing unit that acquires the video image of the past image work belonging to the category, and divides the video image into respective cuts that are sections between which a camera is switched in the video image; and
a script portion identifying unit that acquires the script of the past image work acquired by the cut dividing unit, and identifies script portions that are portions of the script corresponding to the respective cuts.

4. The video processing apparatus according to claim 3, wherein
the preset processing unit includes:
an ID identifying unit that identifies a facial expression/action type ID for identifying presence or absence of a change in a facial expression or an action of a character in the cut, an emotion type ID for identifying an emotion of the character in the cut, and a shot ID for identifying a type of shot in the cut, using the video image divided into the respective cuts and the script in which the script portions have been identified for the respective cuts; and
a score determination unit that determines, for processing targets that are all the cuts in all past image works belonging to the predetermined category, a facial expression/action score calculated in accordance with the number of cuts in which a combination of the facial expression/action type ID and the shot ID is used, an emotion score calculated in accordance with the number of cuts in which a combination of the emotion type ID and the shot ID is used, and a shot switching score calculated in accordance with the number of times the cuts using a combination of the shot IDs before and after switching of the cuts are switched, and
a facial expression/action score table in which the facial expression/action score is registered, an emotion score table in which the emotion score is registered, and a shot switching score table in which the shot switching score is registered are generated as the preset information.

5. The video processing apparatus according to claim 4, wherein
the ID identifying unit
identifies the facial expression/action type ID for each cut by referring to a facial expression/action type correspondence table in which the facial expression/action type ID of the character is associated with information indicating a speaker, and information indicating presence or absence of a change in a facial expression and action of the character,
identifies the emotion type ID for each cut by referring to an emotion type correspondence table in which the emotion type ID of the character is associated with information indicating an emotion type of the character, and
identifies the shot ID for each cut by referring to a shot correspondence table in which the shot ID is associated with information indicating an imaging target, a shot type, a shot size, a shot direction, and a shot angle.

6. The video processing apparatus according to claim 5, wherein
the score determination unit updates the entire facial expression/action score table and the entire emotion score table to change the facial expression/action score and the emotion score corresponding to the shot ID after correction to higher values in the facial expression/action score table and the emotion score table, in accordance with operating information about a user instructing to correct some of the shot IDs to correct the new camerawork, in response to display of the video image of the image work to be newly produced, the video image having been generated by the video generation unit in accordance with the new camerawork, and
the camerawork generation processing unit generates the new camerawork reflecting the correction, by referring to the updated facial expression/action score table and the updated emotion score table.

7. The video processing apparatus according to claim 6, wherein
the camerawork generation processing unit includes:
a timeline data creation unit that creates timeline data formed by turning a timeline into data for each segment that is a section defined by cut point candidates for switching the camera, the timeline representing contents of the new script with dialogues, and actions, facial expressions, and emotions of the respective characters over time;
an ID association unit that associates each segment with the facial expression/action type ID of each character in the segment by referring to the facial expression/action type correspondence table, and associates each segment with the emotion type ID of each character in the segment by referring to the emotion type correspondence table; and
a score identifying unit that refers to the facial expression/action score table and the emotion score table as the preset information about the desired category, and identifies the facial expression/action score and the emotion score for each shot ID assumed to be used in the segment.

8. The video processing apparatus according to claim 7, wherein
the camerawork generation processing unit further includes:
a pattern ID setting unit that sets a pattern ID for a shot ID list in which all patterns of sequences of the shot IDs are listed for each of the segments;
a total score calculation unit that refers to the shot switching scores as the preset information about the desired category, calculates a first total value by summing the shot switching scores for all the shot IDs in accordance with the shot ID list, calculates a second total value by summing the facial expression/action scores and the emotion scores, and calculates a sum of the first total value and the second total value as a total score for each of the pattern IDs; and
a camerawork generation unit that generates the new camerawork in accordance with the shot ID list from which a total score having the greatest value among the total scores for all the pattern IDs has been obtained.

9. The video processing apparatus according to claim 8, wherein,
when presenting a plurality of new cameraworks, the camerawork generation unit generates a plurality of the new cameraworks in accordance with the shot ID lists from which the respective total scores have been obtained, in descending order of the total scores.

10. The The video processing apparatus according to claim 1, wherein
the camerawork includes chronological changes in an imaging target, a shot type, a shot size, a shot direction, and a shot angle.

11. A video processing method implemented by a video processing apparatus,
the video processing method including:
generating, from a video image and a script of a past image work belonging to a predetermined category, preset information in which various scores representing features of a past camerawork used in the image work under the category are registered; and
generating a new camerawork recreating the features of the past camerawork by referring to the preset information under the category desired by a user, on a basis of a new script that is a script of an image work to be newly produced.

12. A program for causing a computer of a video processing apparatus to perform video processing that includes:
generating, from a video image and a script of a past image work belonging to a predetermined category, preset information in which various scores representing features of a past camerawork used in the image work under the category are registered; and
generating a new camerawork recreating the features of the past camerawork by referring to the preset information under the category desired by a user, on a basis of a new script that is a script of an image work to be newly produced.
